(19) United States
(12) Patent Application Publication
(10) Pub. No.: US 2009/0290547 A1
(43) Pub. Date: Nov. 26, 2009

(54) METHOD FOR SCHEDULING WIRELESS NETWORK PACKETS AND APPARATUS THEREOF

(75) Inventors: CHIH KUN CHANG, HSINCHU COUNTY (TW); WEN TSUNG CHUNG, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, Hsinchu County (TW)

(21) Appl. No.: 12/421,160

(22) Filed: Apr. 9, 2009

(30) Foreign Application Priority Data
May 21, 2008 (TW) 097118613

(51) Int. Cl. H04W 72/04

(52) U.S. Cl. 370/329

(57) ABSTRACT

An apparatus for scheduling wireless network packets comprises a DMA, a wireless network packet scheduler, a FIFO buffer and a MAC circuitry. The DMA is configured to access different kinds of wireless network packets from memories through a bus. The wireless network packet scheduler is configured to control the DMA and to allocate the access ratio of the different kinds of wireless network packets based on a standard. The FIFO buffer is configured to store the received wireless network packets. The MAC circuitry is configured to receive the different kinds of wireless network packets from the FIFO buffer.

### BACKGROUND OF THE INVENTION

1. Field of the Invention

The present invention relates to an apparatus and a method for scheduling wireless network packets, and more particularly, to an apparatus and a method for scheduling wireless network packets that features low cost.

2. Description of the Related Art

Traditional wireless networks, e.g., those following the IEEE 802.11 standard, use distributed coordination function (DCF) to control accesses of shared wireless media. The DCF standard regulates that when all wireless media are busy, all devices intending to access the wireless media have to wait for an idle period.

However, as immediate access for real-time applications becomes increasingly important, the issue of quality of service (QoS) increases in importance as well. In other words, real-time applications need to be allocated a higher priority to assure transmission quality. Consequently, The Wi-Fi Group has developed a standard, called Wi-Fi Multimedia (WMM). This standard classifies the transmission signals into four classes, listed in descending order of priority: voice, image, best effort and background. The DCF standard is further modified as enhanced distributed coordination function (EDCF), which allocates idle periods for the four different signal priorities. According to this standard, items of higher priority should have less idle time and higher probability to access the wireless network.

FIG. 1 shows a conventional structural diagram of an apparatus for scheduling wireless network packets which implements the EDCF standard. The apparatus for scheduling wireless network packets 103 is connected to a system memory 101 through a bus 102. The system memory 101 includes an input interface 104 and four dynamic random access memories (DRAM) 105, and is responsible for outputting received wireless packets to the bus 102. The input interface 104 classifies the received wireless packets and stores them to DRAMs 105, which are assigned to store packets with different priorities. The bus 102 is an interface between the system memory 101 and the wireless packet scheduling apparatus 103, and the wireless packet scheduling apparatus 103 accesses the wireless network packets through the bus 102. The wireless packet scheduling apparatus 103 includes a direct memory access (DMA) 106, four buffers 107, a WMM scheduler 108 and a media access control (MAC) circuitry 109. The DMA 106 accesses the wireless network packets from DRAMs 105 through the bus 102. The buffers 107 temporarily store the wireless network packets accessed by the DMA 106. The WMM scheduler 108 controls the DMA 106 to access the wireless network packets in accordance with the EDCF standard, and outputs the wireless network packets to MAC circuitry 109. However, if the bandwidth of the bus 102 is significantly smaller than required to support the access speed of the scheduling apparatus 103, e.g., the bus 102 is a secure digital input-output (SDIO) structure and the WMM scheduler 108 checks the status of the buffer 107 in a round-robin manner, then the buffer 107 will be emptied because the access speed is far faster than the storing speed. When the WMM scheduler 108 examines the status of one of the buffers 107, its corresponding packets are next outputted to the MAC 109, and the buffer is then emptied. Meanwhile, the DMA 106 has not finished the next access instruction of the buffer, and therefore the MAC 109 circularly accesses the four types of wireless network packets of the buffers 107, causing the access probabilities of these four packet types to be equal. In other words, the priorities of these four packet types are substantially the same. Therefore, when the bandwidth of the bus 102 is significantly smaller than required to support the access speed of the wireless packet scheduling apparatus 103, the wireless packet scheduling apparatus 103 cannot reschedule the packets in accordance with the priority order, and fails to follow the EDCF regulation.

### SUMMARY OF THE INVENTION

The apparatus for scheduling wireless network packets in accordance with one embodiment of the present invention comprises a direct memory access (DMA), a wireless network packet scheduler, a first-input-first-output (FIFO) buffer and a media access control (MAC) circuitry. The DMA is configured to access different kinds of wireless network packets from memories through a bus. The wireless network packet scheduler is configured to control the DMA and to allocate the access ratio of the different kinds of wireless network packets based on a standard. The FIFO buffer is configured to store the received wireless network packets. The MAC circuitry is configured to receive the different kinds of wireless network packets from the FIFO buffer.

The apparatus for scheduling wireless network packets in accordance with another embodiment of the present invention comprises a receiver, a wireless network packet scheduler and a buffer. The receiver is configured to receive different kinds of wireless network packets. The wireless network packet scheduler is configured to control the receiver and to allocate the receiving ratio of the different kinds of wireless network packets based on a standard. The buffer is configured to store the received wireless network packets.

The method for scheduling wireless network packets in accordance with another embodiment of the present invention comprises the steps of: monitoring transmissions of wireless network packets; storing the wireless network packets into a buffer; checking whether the buffer has additional space, and determining whether to continue monitoring based on the checking result.

### BRIEF DESCRIPTION OF THE DRAWINGS

The invention will be described according to the appended drawings in which:

FIG. 1 shows a structural diagram of the conventional apparatus of scheduling wireless network packets that implements the EDCF standard;

FIG. 2 shows a scheduling apparatus applied to wireless network packets in accordance with one embodiment of the present invention; and

FIG. 3 shows a flow chart of a scheduling method in accordance with one embodiment of the present invention.

### PREFERRED EMBODIMENT OF THE PRESENT INVENTION

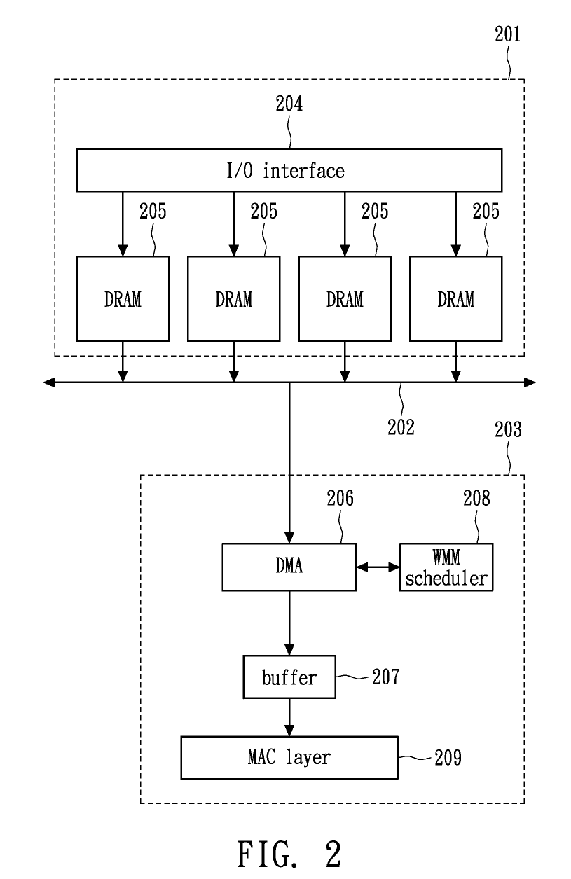

FIG. 2 shows a scheduling apparatus applied to wireless network packets in accordance with one embodiment of the present invention. The scheduling apparatus 203 is connected to a system memory 201 through a bus 202. The system memory 201 includes an input interface 204 and four DRAMs 205, and is responsible for outputting received wireless network packets to the bus 202. The input interface 204 classifies the received wireless network packets based on their priority and stores them into the DRAMs 205. The bus 202 is an interface between the system memory 201 and the scheduling apparatus 203, e.g., peripheral component interconnect (PCI), universal serial bus (USB) or SDIO. The scheduling apparatus 203 accesses the wireless network packets through the bus 202, and includes a DMA 206, a buffer 207, a WMM scheduler 208 and a MAC unit 209. The DMA 206 accesses the wireless network packets stored in the DRAM 205 through the bus 202. The WMM scheduler 208 controls the DMA 206 to access the wireless network packets in accordance with the EDCF protocol, and stores them in the buffer 207. The MAC unit 209 directly receives the wireless network packets from the buffer 207.

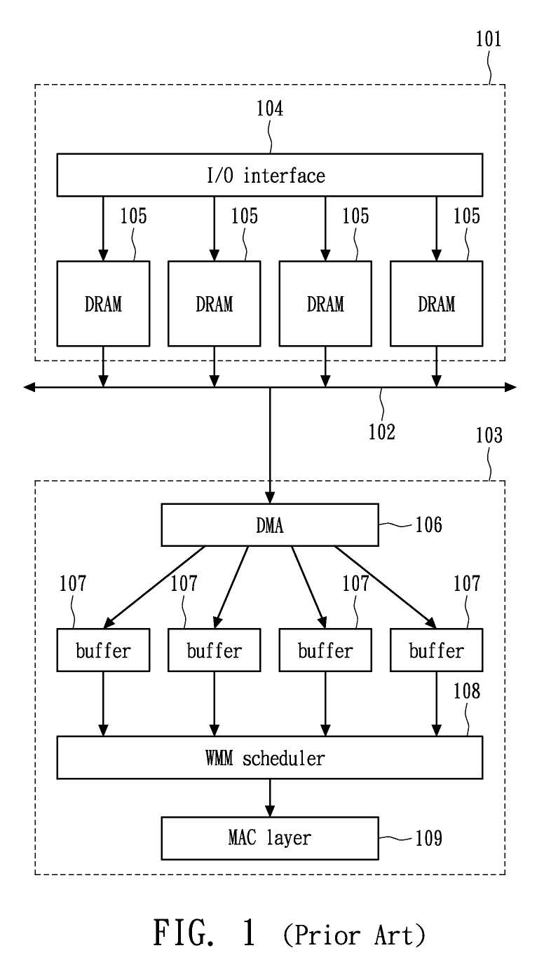

Compared to the scheduling apparatus 103 shown in FIG. 1, the scheduling apparatus 203 in FIG. 2 pulls the WMM scheduler 208 up from corresponding buffer 207 to DMA 206. In other words, the WMM scheduler 108 in FIG. 1 examines how the buffer 107 decides to access the packets, while the WMM scheduler 208 in FIG. 2 directly accesses the DRAM 205 through the DMA 206 so as to avoid being affected by the buffer 207. In addition, the quantity of buffers 207 needed for the scheduling apparatus 203 is reduced from four to one, and is easily arranged by a FIFO buffer. Preferably, the size of the buffer 207 is arranged to be twice the maximum frame size of the packets to avoid head-off-line (HOL) situations caused by low-priority packets.

If the bandwidth of the bus 202 is significantly smaller than required to support the access speed of the scheduling apparatus 203, even though the access speed for the buffer 207 is greater than the storing speed for the buffer 207, the WMM scheduler 208 is not affected by the quantity of packets in the buffer 207 because it directly accesses the packets from the DMA 206. Therefore, even though in the short term the quantity of packets received by the MAC unit 209 will be affected by the bandwidth of the bus 202, in the long term the ratio of each type of received packets will satisfy the EDCF regulation. Furthermore, the specification that the quantity of needed buffers 207 is reduced to one effectively reduces necessary area and power consumption, and achieves the purpose of cost reduction.

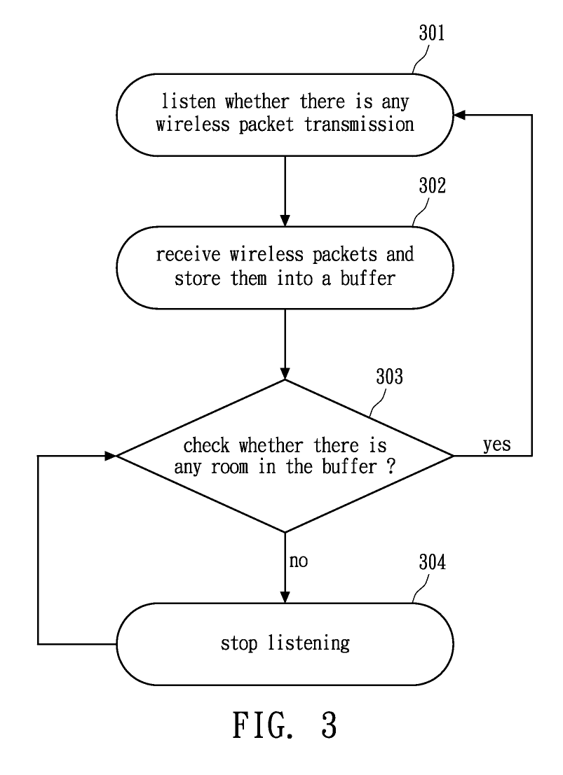

FIG. 3 shows a flow chart of a scheduling method in accordance with one embodiment of the present invention. In Step 301, the transmitted wireless network packets are received. In Step 302, the wireless network packets are received from the bus and stored in a buffer. If packet collision occurs, the packet-receiving priority is determined by the Wi-Fi Multimedia standard. In Step 303, it is determined whether there is any available space in the buffer. If affirmative, Step 301 is repeated, and monitoring of packet transmission is continued. Otherwise, Step 304 is performed. In Step 304, monitoring is halted and the flow returns to Step 303.

In conclusion, the present invention is suitable to a low-cost scheduling apparatus for wireless network packets, especially for a wireless network system complying with the IEEE 802.11x standard.

The above-described embodiments of the present invention are intended to be illustrative only. Numerous alternative embodiments may be devised by persons skilled in the art without departing from the scope of the following claims.

What is claimed is:

1. An apparatus for scheduling wireless network packets, comprising:
a direct memory access (DMA) configured to access different kinds of wireless network packets from memories through a bus;
a wireless network packet scheduler configured to control the DMA and to allocate the access ratio of the different kinds of wireless network packets based on a standard;
a buffer configured to store the received wireless network packets; and
a media access control (MAC) circuitry configured to receive the different kinds of wireless network packets from the buffer.

2. The apparatus of claim 1, wherein the standard complies with a Wi-Fi Multimedia standard.

3. The apparatus of claim 2, wherein the standard is an enhanced distributed coordination function (EDCF) standard.

4. The apparatus of claim 1, wherein the bus is a programmable communication interface or a universal serial bus (USB).

5. The apparatus of claim 1, wherein the bus is a secure digital input-output (SDIO).

6. The apparatus of claim 1, wherein the buffer is a first-input-first-output (FIFO) buffer and the capacity of the FIFO buffer is substantially twice the frame size of the wireless network packets.

7. The apparatus of claim 1, which is applied in a wireless network system complying with the Institute of Electrical and Electronics Engineers (IEEE) 802.11x standard.

8. An apparatus for scheduling wireless network packets, comprising:
a receiver configured to receive different kinds of wireless network packets;
a wireless network packet scheduler configured to control the receiver and to allocate the receiving ratio of the different kinds of wireless network packets based on a standard; and
a buffer configured to store the received wireless network packets.

9. The apparatus of claim 8, wherein the standard complies with a Wi-Fi Multimedia standard.

10. The apparatus of claim 9, wherein the standard is an enhanced distributed coordination function (EDCF) standard.

11. The apparatus of claim 8, wherein the receiver receives the wireless network packets from a bus.

12. The apparatus of claim 11, wherein the bus is a secure digital input-output (SDIO).

13. The apparatus of claim 8, which is applied in a wireless network system complying with the IEEE 802.11x standard.

14. The apparatus of claim 8, wherein the buffer outputs the different kinds of wireless network packets to a processing unit of a media access control (MAC) circuitry.

15. A method for scheduling wireless network packets, comprising the steps of:
monitoring transmissions of wireless network packets;
storing the wireless network packets into a buffer; and
checking whether the buffer has additional room, and determining whether to continue monitoring based on the checking outcome.

16. The method of claim 15, wherein the listening and receiving steps aim at a bus.

17. The method of claim 15, wherein the receiving step determines a packet-receiving priority if a packet collision occurs.

18. The method of claim 16, wherein the standard complies with a Wi-Fi Multimedia standard.

19. The method of claim 15, wherein the monitoring is suspended if the checking outcome shows no space is available in the buffer.

20. The method of claim 15, which is applied in a wireless network system complying with the IEEE 802.11x standard.
